(19) United States
(12) Patent Application Publication
(10) Pub. No.: US 2003/0005101 A1
(43) Pub. Date: Jan. 2, 2003

(54) Network administration management utility

(76) Inventor: Edward George Falzon, Queensland (AU)

Correspondence Address: YOUNG & THOMPSON, 745 SOUTH 23RD STREET 2ND FLOOR, ARLINGTON, VA, 22202

(21) Appl. No.: 09/895,200

(22) Filed: Jul. 2, 2001

(51) Int. Cl. G06F 9/46; G06F 9/00; G06F 15/173

(52) U.S. Cl. 709/223; 709/316

(57) ABSTRACT

A network administration management utility for a hierarchical tree structure in an computer network, the utility employs a graphical user interface having windows for browsing trees in the network and then selecting source objects from the trees and adding them to a source object list A destination list is generated the same way. Options for processing the source objects to the destinations are selectable including maintenance of the source objects relative associations at the destination independent of the absolute associations at the source. Any missing associations are automatically created at the destination when the lists are processed. All listed source objects are processed to all the listed destination upon clicking a single button The utility includes the full range of deploy, update and replacement process relating to multiple object types across different trees including, associations, Link folders and Application site lists in a ZENworks environment. In addition the utility includes separate object field management tool that enables interrogation of fields in multiple objects in preselected branches and if desired alteration of object fields.

### FIELD OF THE INVENTION

THIS INVENTION relates to a network administration/management utility particularly suited for but not limited to an NDS (Novell Directory Services) environment.

Computer networks often include multiple servers each serving multiple workstations known as “clients”. Under an NDS environment, applications are managed through the use of application objects in a hierachical directory services database.

A network administrator is usually responsible for maintaining the database and applications running on the network up to date. U.S. Pat. Nos. 5,692,129 and 5,859,978, the disclosure of which are incorporated herein by reference describe methods for managing application programs in a computer network by using an NDS database.

Tools have been developed to enable a network administrator to maintain a network from a single point in the network typically involving copying and upgrading processes. For example, in an NDS environment such as Novell's ZENworks® (ZENworks® is the registered trade mark of Novell Inc), a free toolkit known as the “ZENworks Toolkit” has been used. Novell have also released a product known as TED (Tiered Electronic Distribution). Novell also provides two general network administration utilities, their Netware Administrator (NW Admin) and ConsoleOne.

The ZENworks toolkit and TED are specifically ZENworks' tools while NW Admin and ConsoleOne have functionality with other Novell products Each product has its own advantages and disadvantages but generally speaking none of these are able to automate deployment and upgrade operations. Generally, individual objects must be copied by the administrator or under TED an administrator must create SDO's (site distribution objects) one by one to each application object the is to be deployed. The SDO can then be used for future administration but any changes to the trce structure requires new SDO's. While there is the advantage of automation once all the SDO's are in place this arrangement lacks flexibility In addition these tools restrict any single operation to a single tree so it is not possible to mix operations across different trees.

It is an object of the present invention to provide a network administration/management utility that represents an advance over the aforementioned prior art utilities.

### SUMMARY OF THE INVENTION

In one aspect therefore the present invention provides a network administration management utility for a hierarchical tree structure in an computer network, the utility comprising program means enabling user selection of source objects creating an object list, program means enabling user selection of destinations creating a destination list while connected to the network, program means enabling user selection of operations to be processed and program means automatically processing the selected operations in accordance with said lists.

In a second aspect there is provided a network administration management utility for management of object fields in a hierarchical tree structure in a computer network, the utility including program means enabling interrogation of object fields in multiple objects. Preferably, there is provided program means enabling user initiated synchronisation of selected fields across selected objects.

Preferably, the selected operations includes program means automatically deploying the selected objects and includes program means enabling upgrade or synchronisation of existing objects at the selected destinations.

Preferably, the selected operations includes program means automatically deploying the selected objects includes program means to replace an existing object at a selected destination by first deleting the existing object.

Preferably, the network administration management utility further comprises program means enabling a search to identify objects with the same field values.

Preferably, the network administration management utility further comprises program means enabling associations of a source object not present at a selected destination to be automatically created upon deployment of the object to the selected destination.

Preferably, the network administration management utility further comprises program means enabling comparison object fields.

Preferably, the network administration management utility further comprises program means enabling changes to an object to be automatically documented to maintain a history of actions performed in relation to that object.

Preferably, the network administration management utility further comprises program means enabling retention of a source objects GUID at a selected destination or allocation of a new GUID.

Preferably, the network administration management utility further comprises program means enabling the same destination list to include destinations in different trees.

Preferably, the network administration management utility further comprises a graphical user interface having a window showing a selected object tree and respective object and destination list windows.

### BRIEF DESCRIPTION OF THE DRAWINGS

FIG. 1 is a screen shot of the basic program interface illustrating six separate windows which the administrator can move and resize;

FIG. 2 is a screen shot of the interface showing the “Deployment view” which opens the “Deployment Manager Options” window;

FIGS. 3-6 are variations of the “objects available” window of FIG. 1 displaying objects filtered according to the objecttypes selected in the check boxes;

FIGS. 7-10 illustrate the options available in the four tabs of the “Deployment Manager Options” window;

FIG. 11 is a screen shot of the interface showing the “GUID View” which opens the “GUID Manager Options” window revealing GUID status for individual objects;

FIGS. 12-14 illustrate the options available in the three tabs of the “GUID Manager Options” window;

FIG. 15 is a screen shot of the interface showing the “Upgrade View” which opens the “Upgrade Manager Options” window;

FIGS. 16-19 illustrate the options available in each of the tabs of the “Upgrade Manager Options” window;

FIG. 20 is a hierarchical process chart showing the overall program layout relative to the Flow Charts which for clarity of relationship are numbered 1 through 10.1 in FIG. 20 and are as follows, the chart flow for any instance being consequential upon options selected via the interface of FIGS. 1 to 19;

FIG. 21 is a table illustrating processing of “relative associations”;

Chart 1 is the overall operation chart showing program process sequence with numerals 2, 3 and 4 indicating process under those charts;

Chart 2 is a flow chart showing the program process sequence corresponding to the “validate license file information” box of Chart 1;

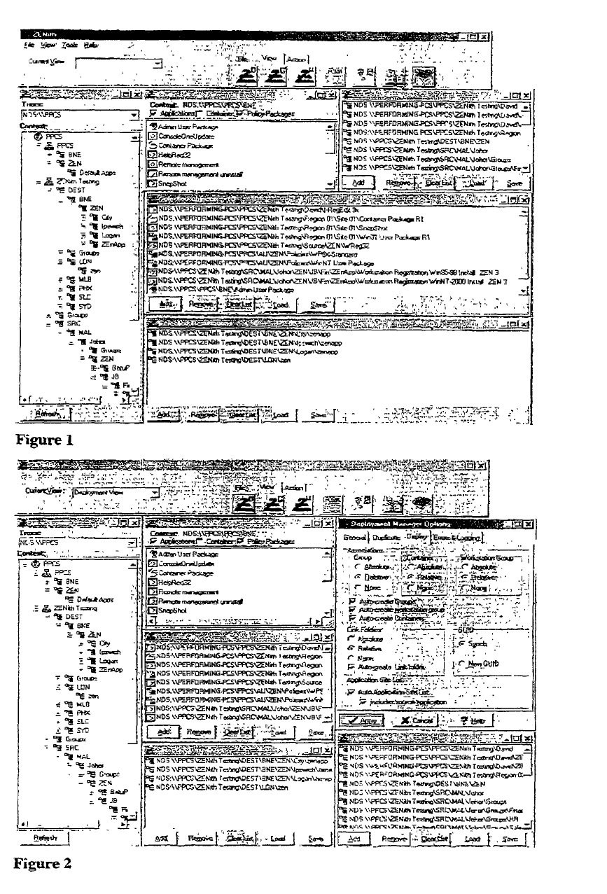

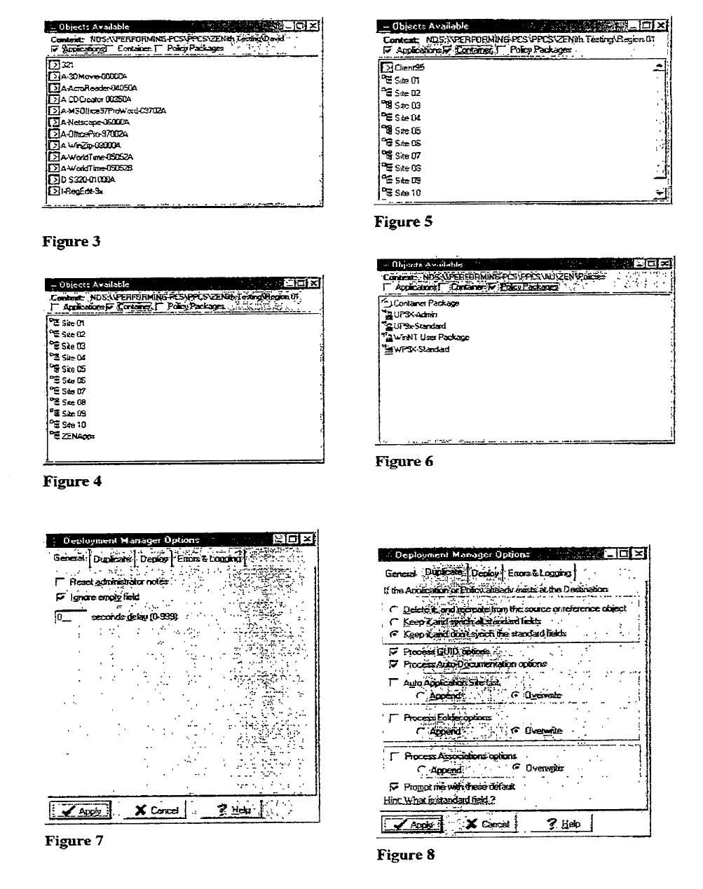

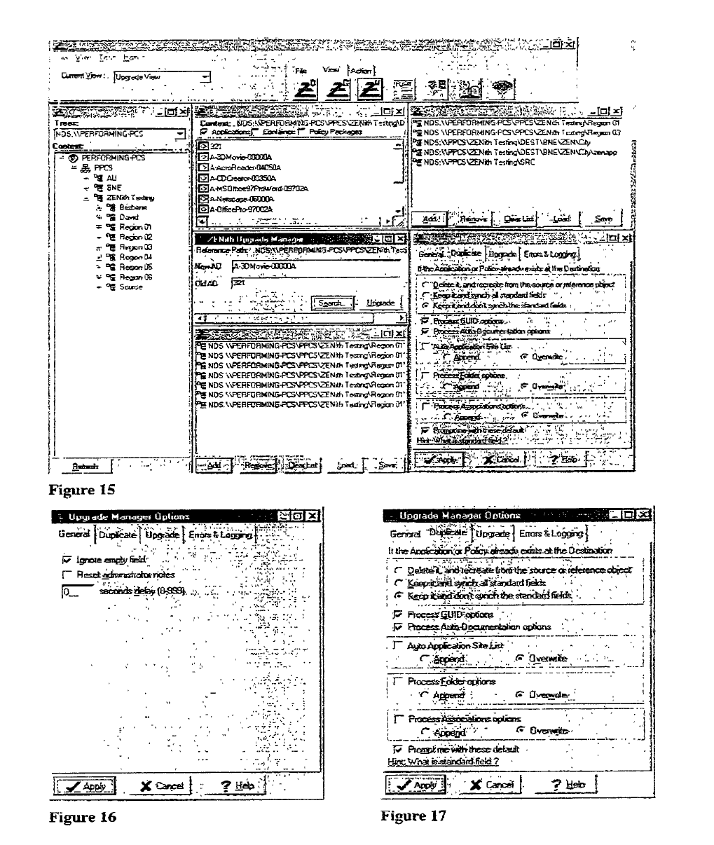

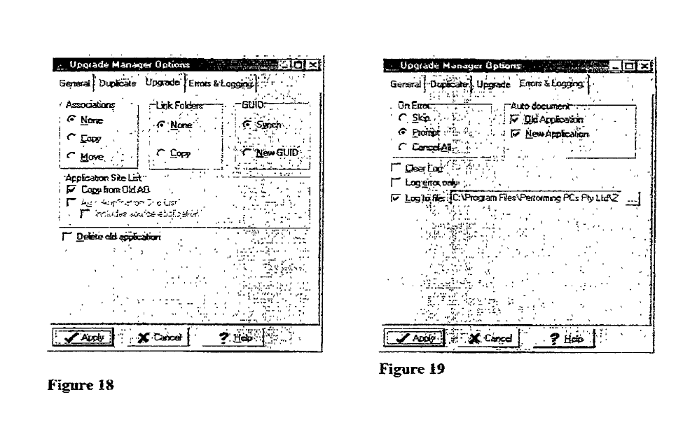

Chart 3 is a flow chart showing the program process sequence corresponding to the “User configures and Initiates Desired Operation” box of Chart 1 effectively utilising the graphical user interface of FIGS. 1-19;

Chart 4 is a flow chart showing the program process sequence corresponding to the “Process Operation” box of Chart 1;

Chart 5 is a flow chart showing the program process sequence corresponding to the “Deploy Objects” box of Chart 4;

Chart 6 is a flow chart showing the program process sequence corresponding to the “Manage fields” box in Chart 4;

Chart 7-1 is a flow chart showing the program process sequence corresponding to the “Find Synched” box of Chart 6;

Chart 7-2 is a flow chart showing the program process sequence corresponding to the “Branch Walk” box of Chart 6;

Chart 8.1 is a flow chart showing the program process sequence corresponding to the “Process Deployment” box of Chart 5;

Chart 8.2 is a flow chart showing the program process sequence corresponding to the “Process Options for Duplicate Object” box of Chart 5;

Chart 8.31 is a flow chart showing the program process sequence corresponding to the “Process Association Options” box of Charts 8.1 and 8-2;

Chart 8.32 is a flow chart showing the program process sequence corresponding to the “Process link folder options” box of Charts 8.1 and 8.2;

Chart 8.33 is a flow chart showing the program process sequence corresponding to the “Process Application Site List Options” box of Charts 8.1 and 8.2;

Chart 9.1d is a flow chart showing the program process sequence corresponding to the “Deployment Associations” box of Chart 8.31;

Chart 9.1u is a flow chart showing the program process sequence corresponding to the “Upgrade Associations” of Chart 8.31;

Chart 9.1d is a flow chart showing the program process sequence corresponding to the “Deploy Link Folders” box of Chart 8.32,

Chart 9.2u is a flow chart showing the program process sequence corresponding to the “Upgrade Link Folders” box of Chart 8-32;

Chart 9.3d is a flow chart showing the program process sequence corresponding to the “Deploy Application Site List” box of Charts 8.33 and 9-3u;

Chart 9.3u is a flow chart showing the program process sequence corresponding to the “Upgrade Application Site List” box of Chart 8.33;

Chart 9-4 is a flow chart showing the program process sequence corresponding to the “Process GUID” box of Charts 8-1 and 8.2;

Chart 10 is a flow chart showing the program process sequence corresponding to the “Apply Relative Associations” box of Charts 9.1d and 9.1u;

Chart 10.1 is a flow chart showing the program process sequence corresponding to the “Determine Relative Associations” box of Chart 10.

### METHOD OF PERFORMANCE

Referring to the drawings and charts, a preferred embodiment of the invention will now be described. The following example is in relation to an NDS (Novell Directory Services) environment but the invention is not so limited as the invention may be applied to any network, consequently the expression “object” should also be considered non-limiting referring to any entity created for computing purposes that may be distributed across a network.

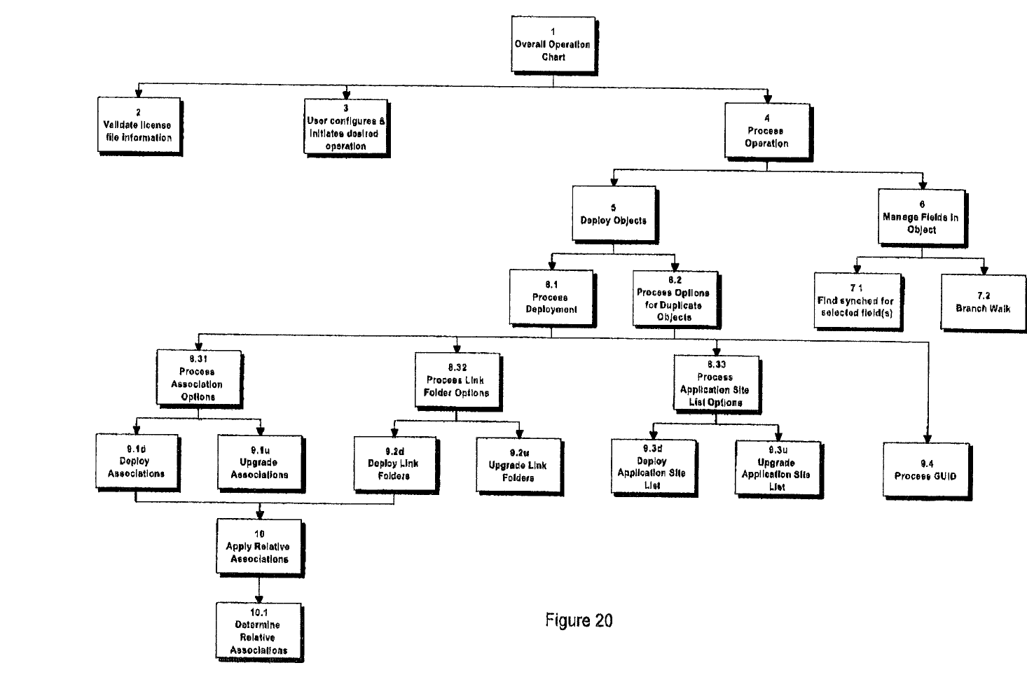

FIG. 20 shows the hierarchical structure of the flow charts and the terms and expressions used in the flow charts have there usual meaning. Generally speaking a person skilled in the art will be able to implement the invention by reference to the Figures and flow charts, but the following description highlights important aspects of the invention that may not be readily apparent.

The options available in the decision boxes of the flow charts generally refers to the available options shown in the interface of FIGS. 1 to 19 as check boxes and radio buttons.

The program need only be installed on one workstation in a network. It need not be installed on a server. All that is required is that the administrator have authorization to browse all trees where operations are to be performed.

Referring to FIG. 1 objects available appear automatically in the “object available” window according the highlighted selection in the “Tree Browse” window In this example “BNE” has been selected. Objects, destinations and branches may be added to the corresponding windows by highlighting a selection in the “Tree Browse” window or in the “objects available” window and clicking the corresponding “Add” button. Lists may be saved for future use. Branches that are to be searched or otherwise interrogated as part of the field management program may be selected and added to the “selected branches” window.

A saved list may be loaded into any of the three windows for later execution UNC format is employed.

To deploy source objects once the administrator has added entries in the “selected objects” window or loads a list and then adds destinations in the “selected destinations” window or loads a list he simply clicks a button of the “ACTION” tab to deploy with all selected options for deployment. Options are selected from other windows described as follows.

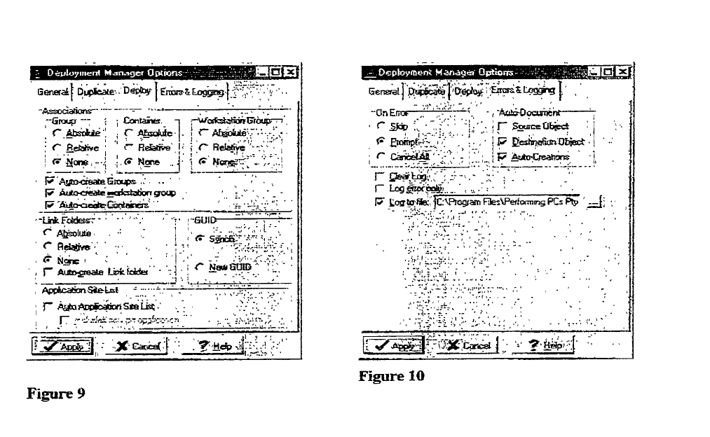

In FIG. 2 the “Deployment view” is selected in the drop down menu, this opens the “Deployment Manager Options” window while keeping the other selection windows open. This window also appears in FIG. 9, the other tabs are in FIGS. 7, 8 and 10.

The “Associations” options in the “Deployment Manager Options” allows the option shown to be implemented at the selected destinations. Selection of “Relative Association” causes a program sequence to interpret the source objects associations of group, containers and workstation group and configure the destination object to be automatically associated with the local (i.e. at the destination) instances of the same group, container and workstation group names, if these are not present they are automatically created to maintain the same relativity for the destination object as for the source object by reason of selection of the “Auto-create” option in the check boxes shown. An example of implementation of relative association is given below with reference to Charts 10 and 10.1:

Source AO (Application Object) is App1, in the Apps Container, which is in the NewYork Container (In NDS terms the Distinguished name of the AO is App1.Apps.NewYork)

App1 is associated to Group1 in the Groups Container, also under the NewYork Container (“Group1 Groups.NewYork”).

Source AO has been copied to Apps-Ohio and Apps.Seattle, respectively.

The process for Relative Association is performed on each AO, immediately after it has been copied/deployed:

(Begin Chart 10-1) “Absolute” UNC path for Source AO is determined NDS:\\Tree1\NewYork\Apps\App1

“Absolute” UNC path for Source Associated Object is determined NDS:\\Tree1\NewYork\Groups\Group1

“Relative” UNC path for Source Associated Object is determined “- - - \Groups\Group1”

Relative path is searched for a like-named object to associate to the destination object, if not present, option to auto-create.

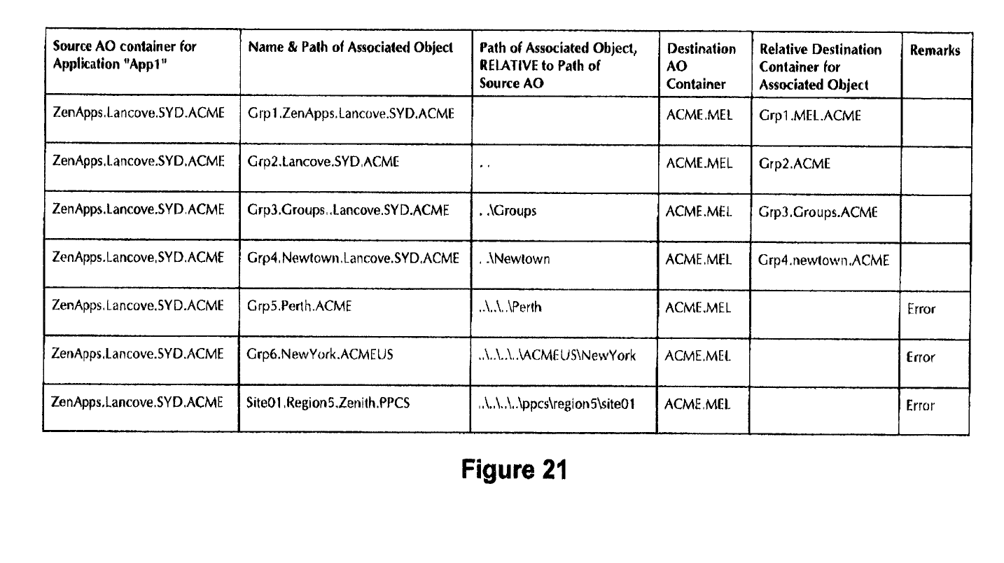

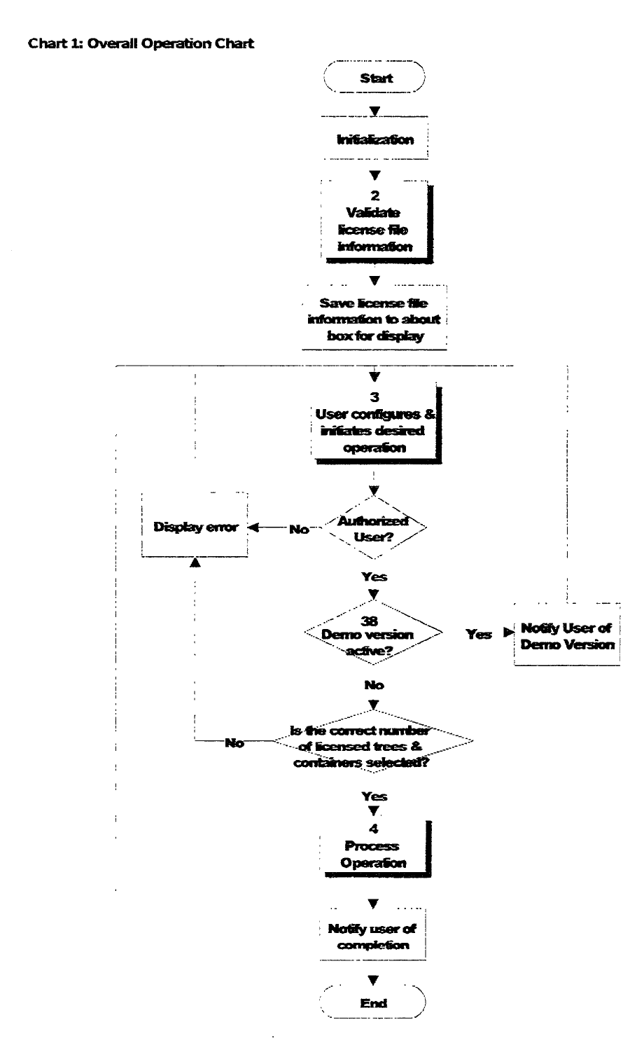

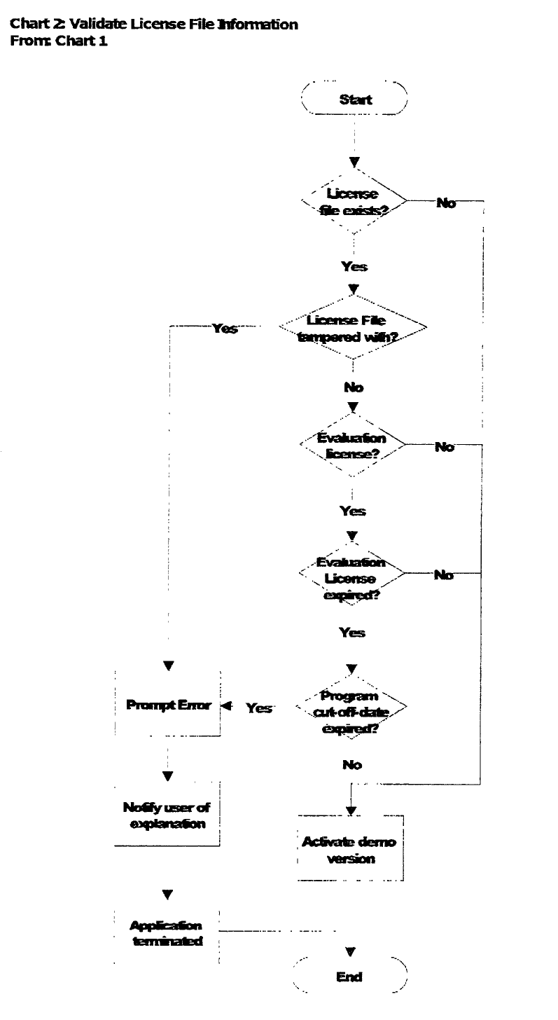

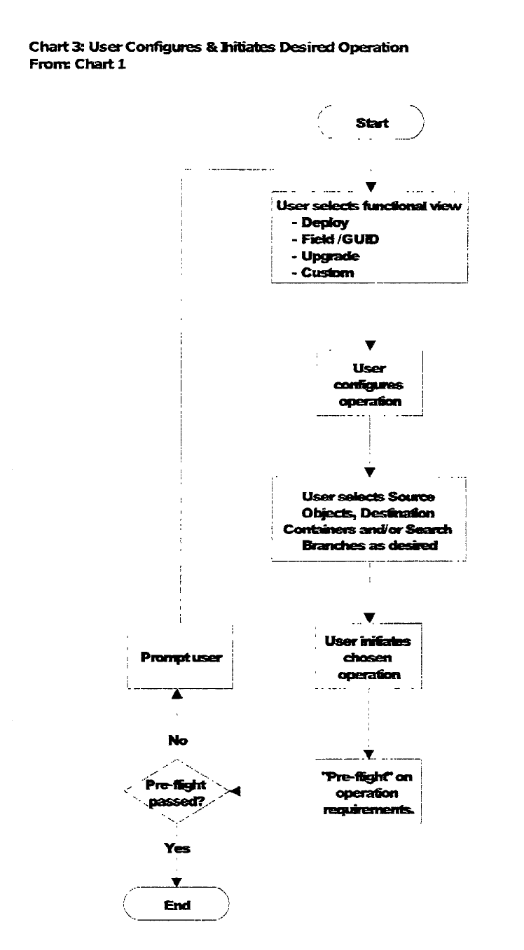

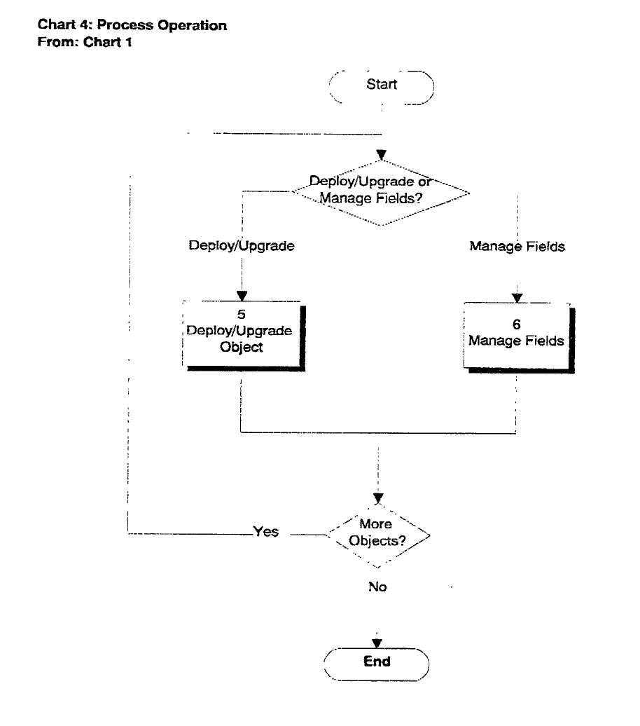

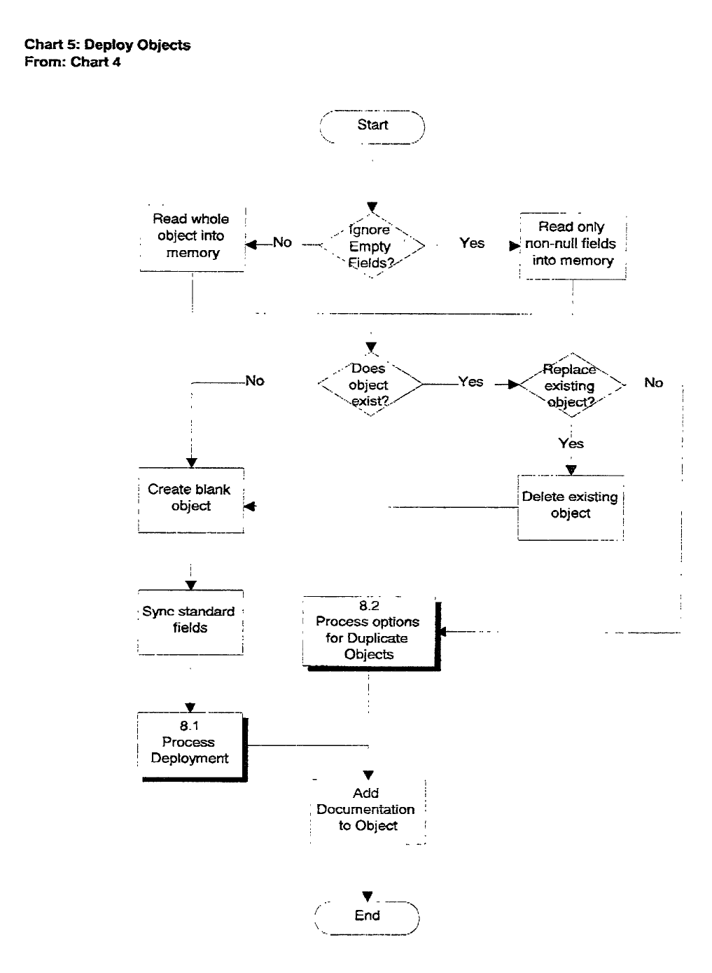

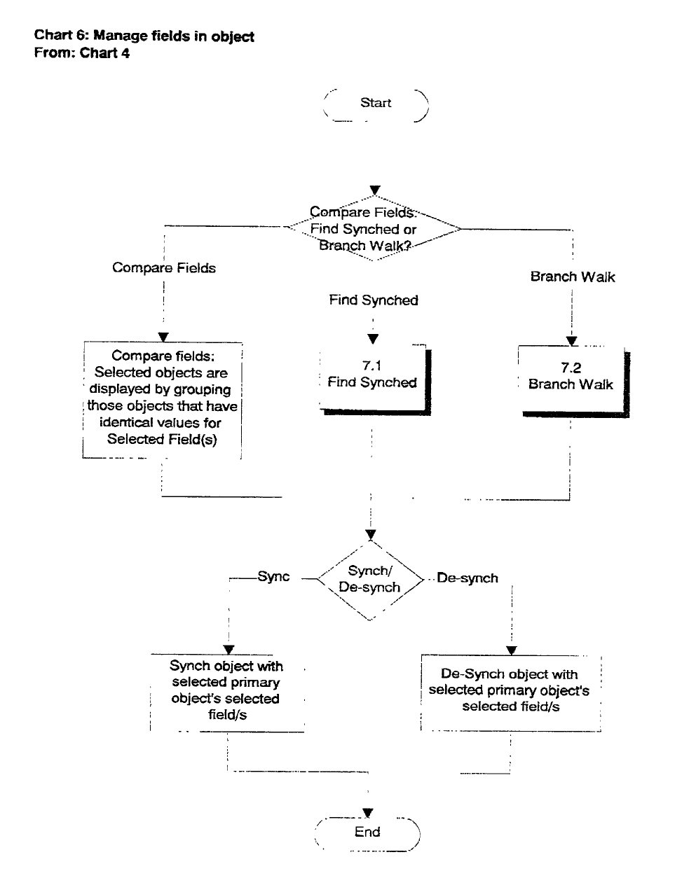

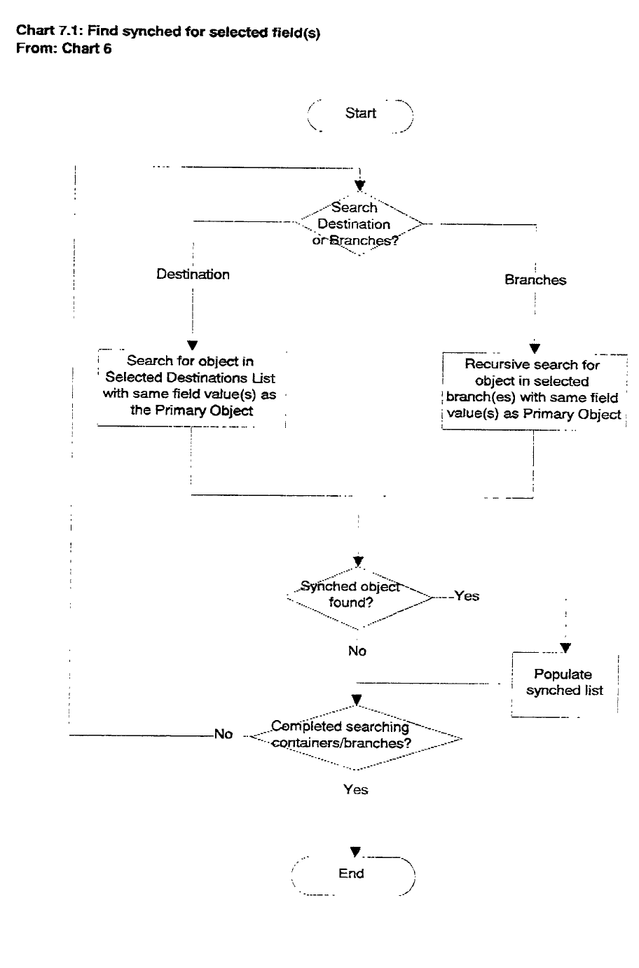

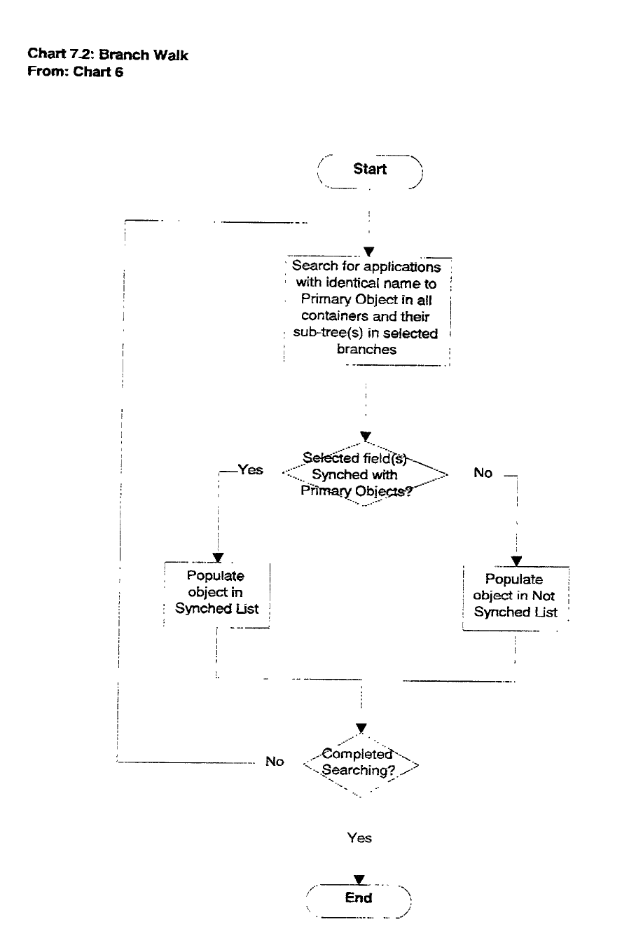

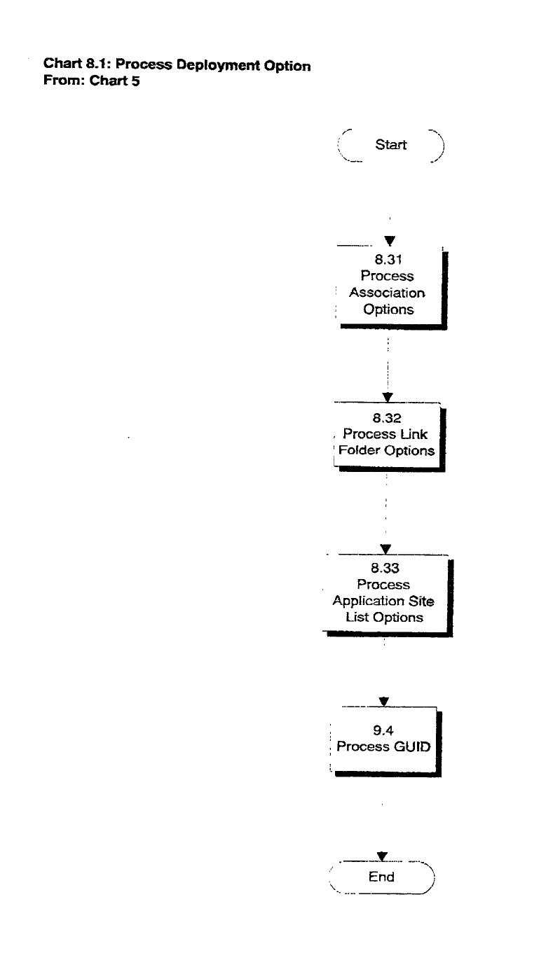

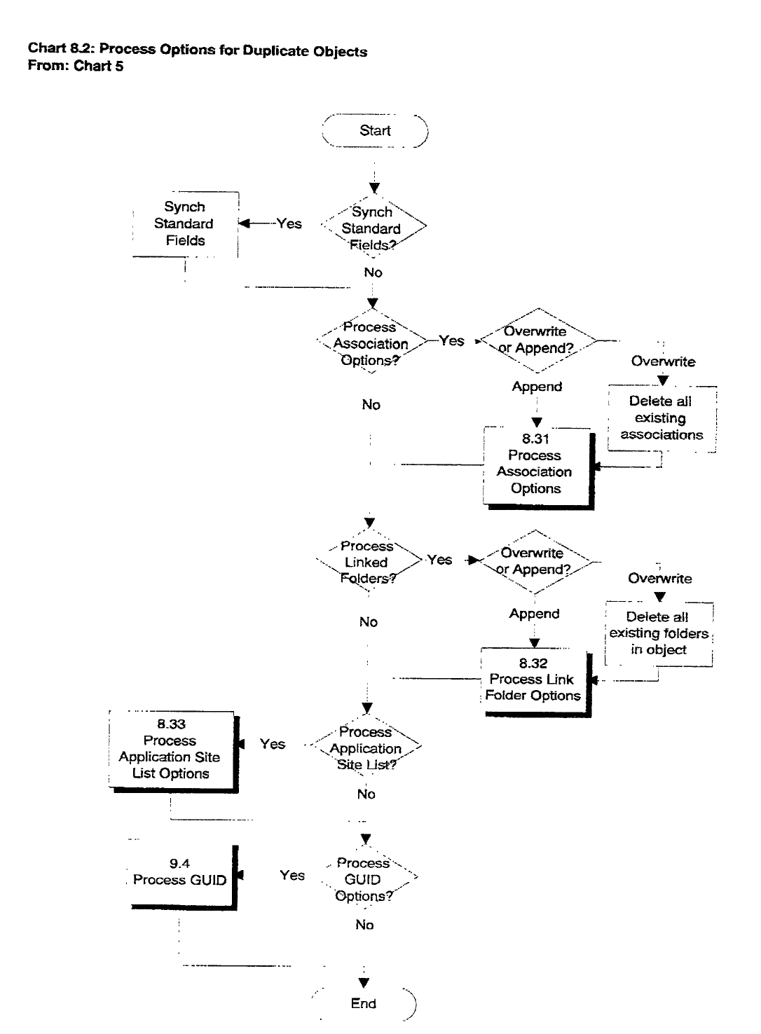

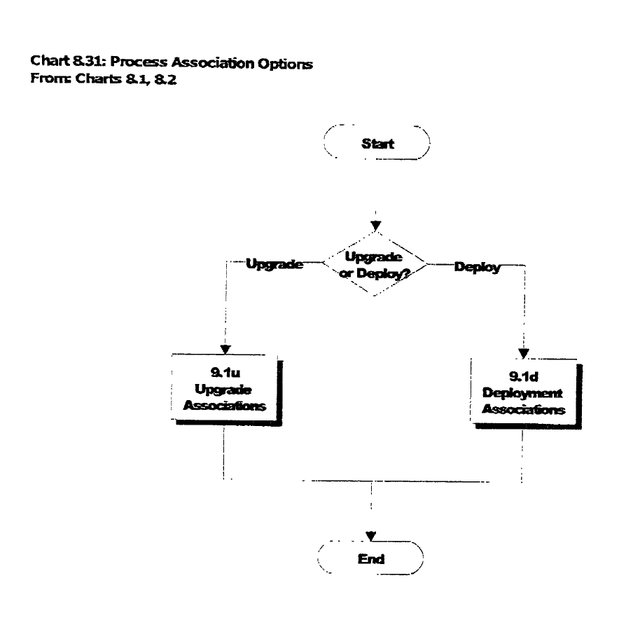

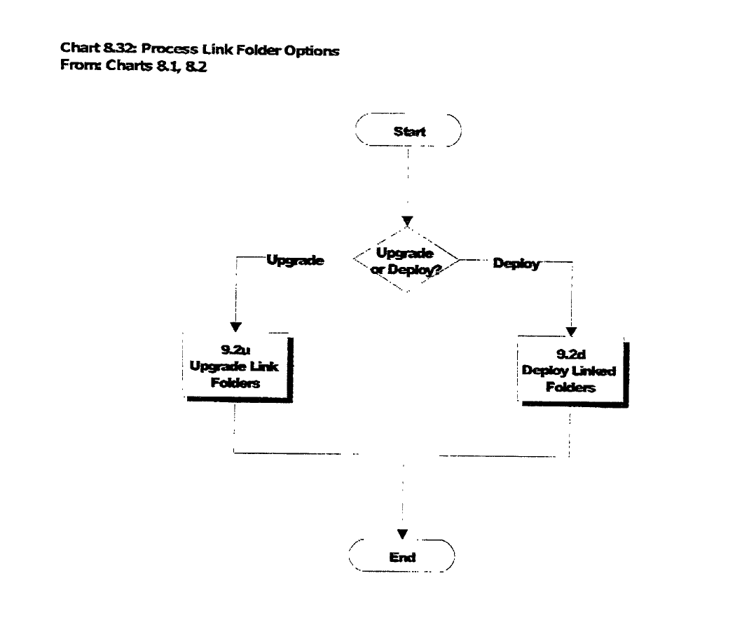

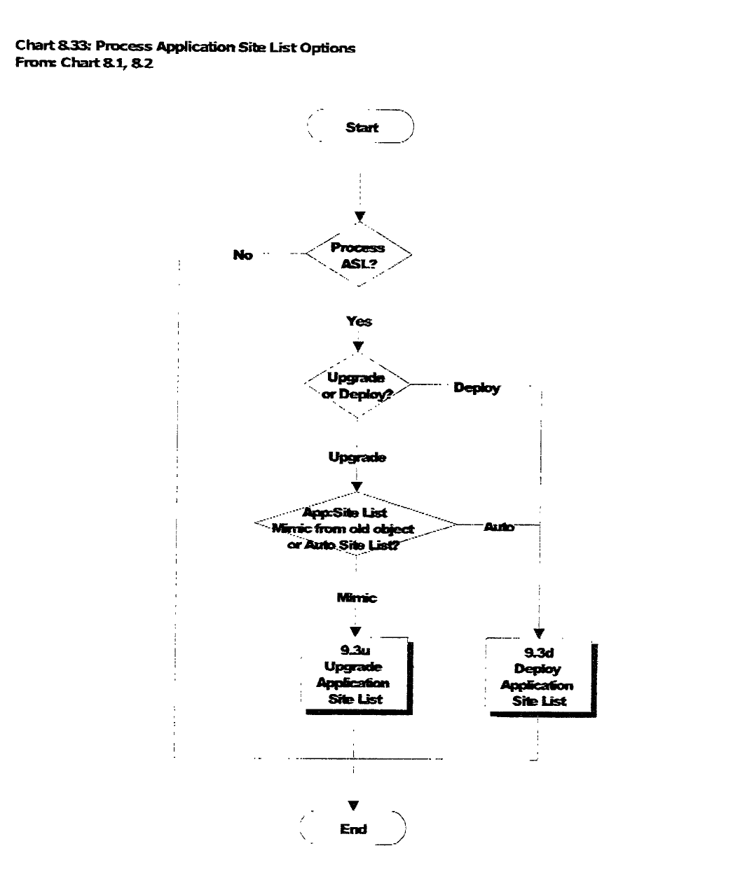

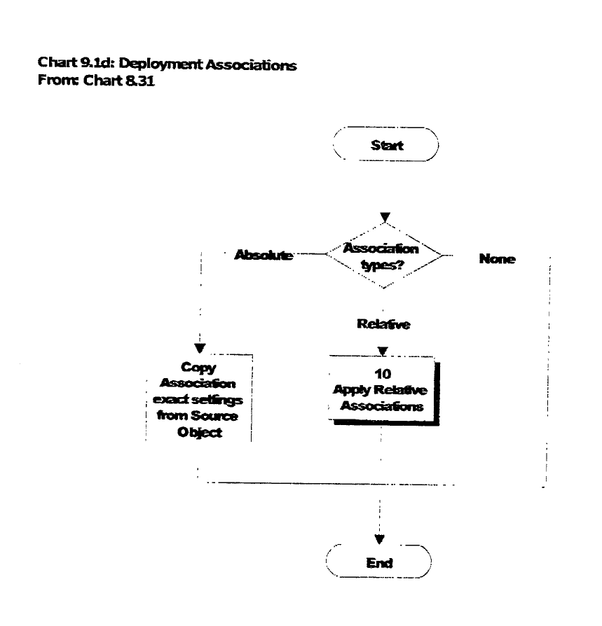

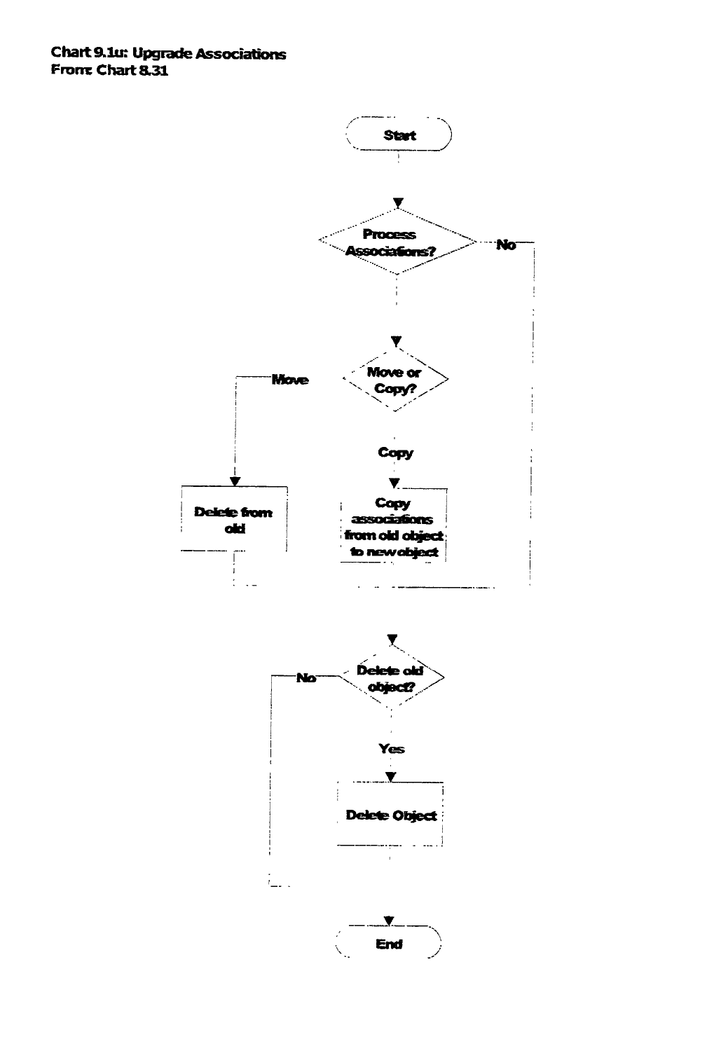

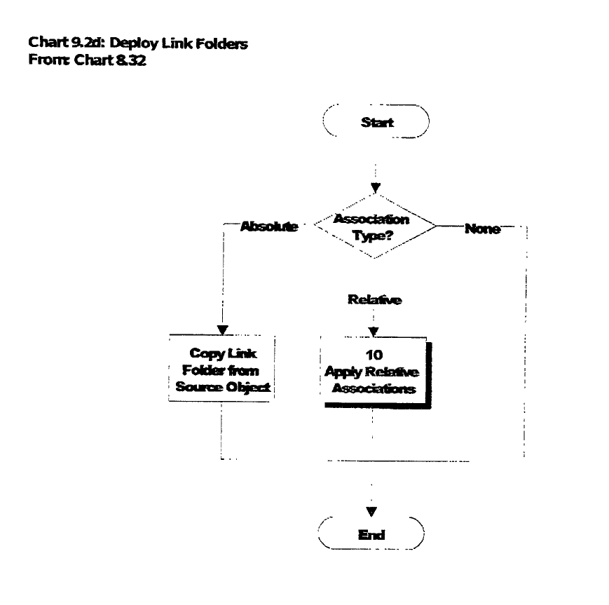

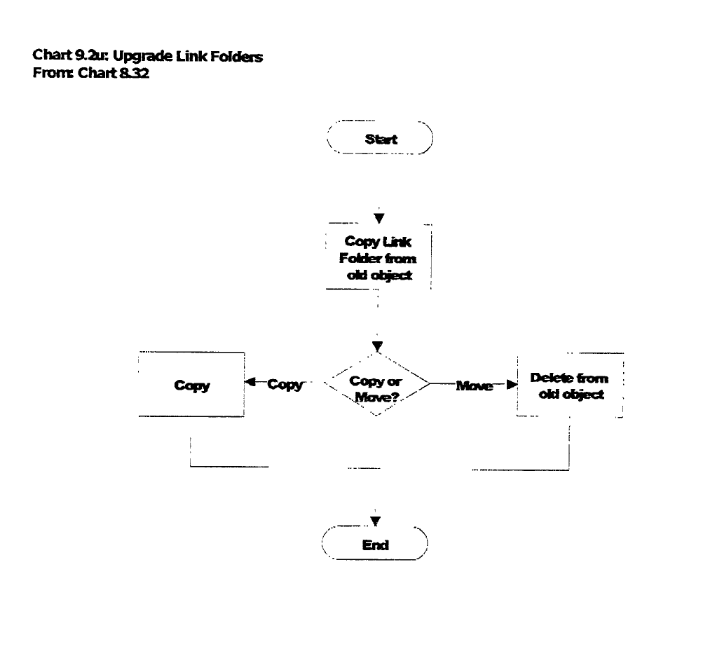

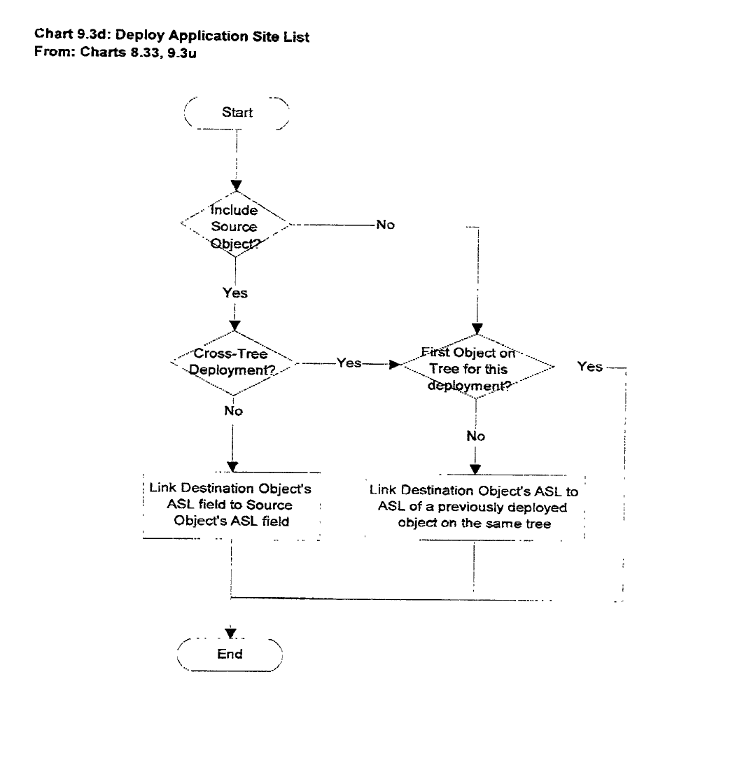

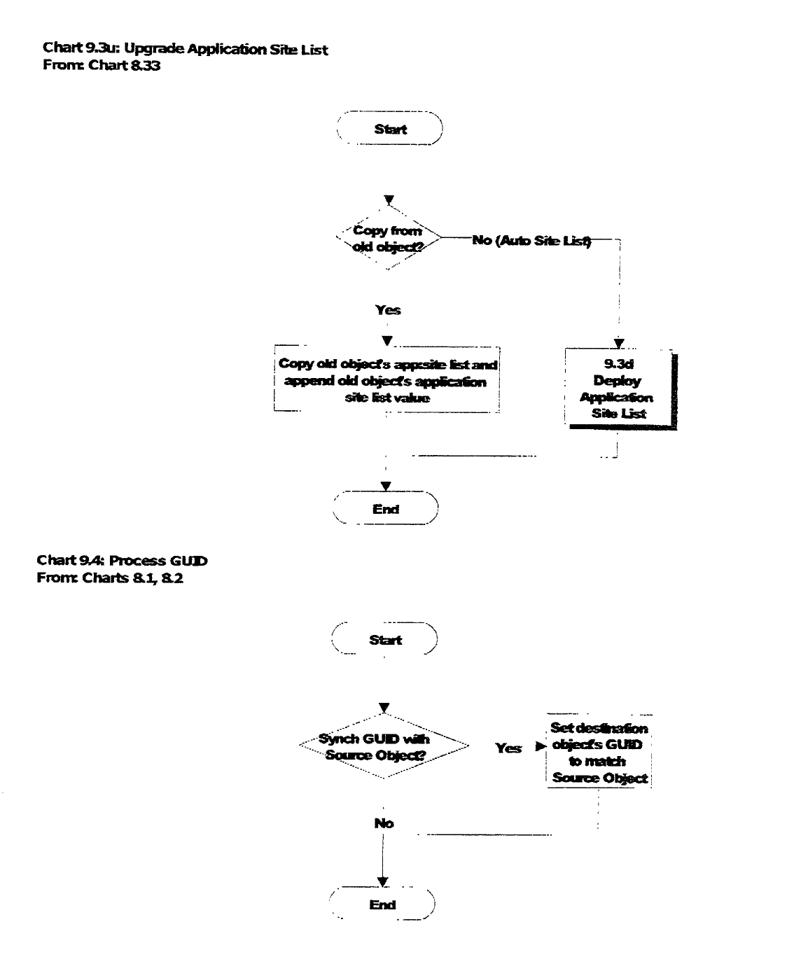

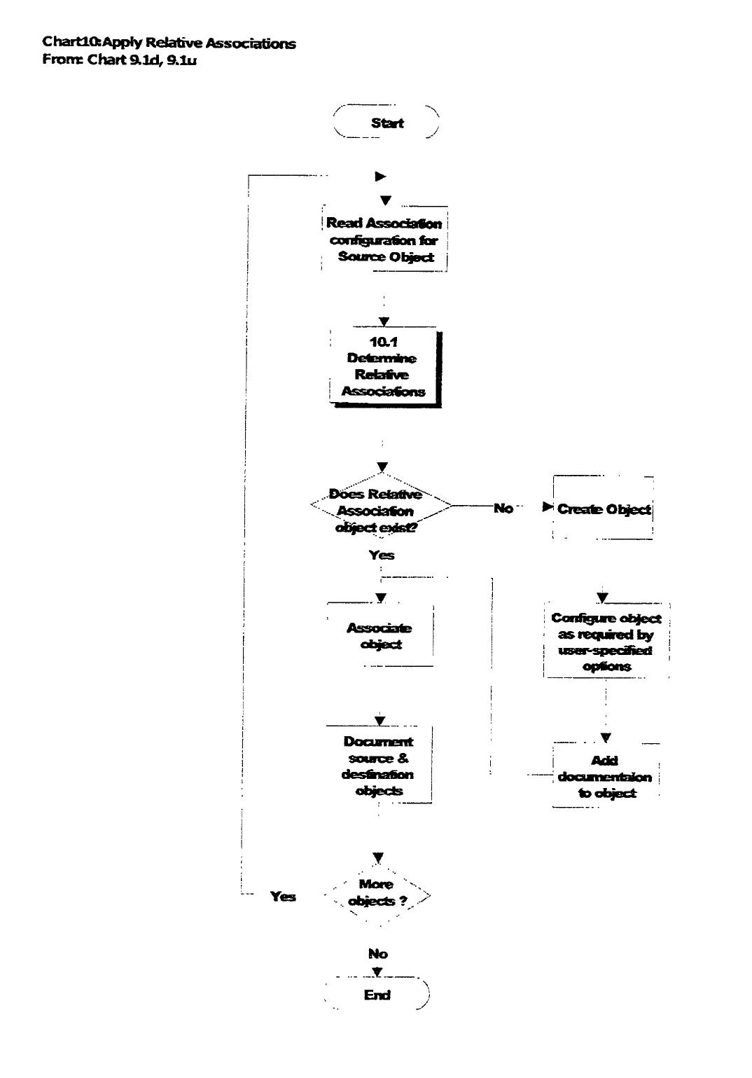

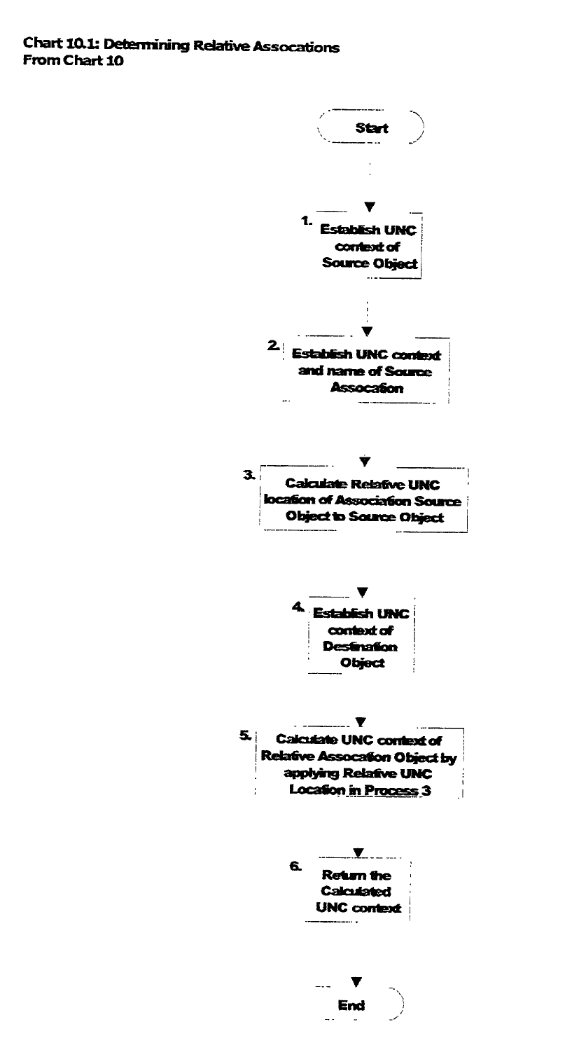

FIG. 21 illustrates a typical process with the outcome of the “auto-create relative associations” process sequence from the source paths to the destination paths using the process of the charts 10 and 10.1.

The “Link Folders” options enables “linked folders” common to application objects in an NDS environment to be created at the destination to maintain the same application object/linked folders relationship with if necessary auto-created link folders if the linked folders do not exist (see charts 8.32, and 9.2d). The GUID (global unique identifier) options enable the GUID's of the source objects to be applied at the destination or new GUID's to be generated. (See charts 8.1, 8.2 and 9.4).

The Application site list is a standard Zenworks ASL created automatically by linking using “App:Site List”.

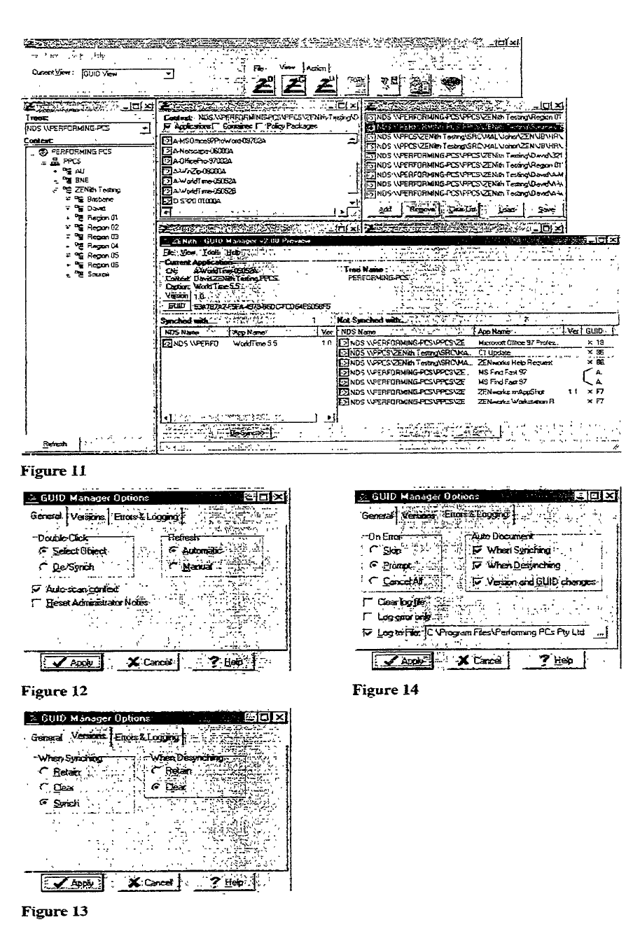

FIG. 8 represents selection of options for chart 8.2., while FIG. 10 sets the error and auto-documentation options.

It should be appreciated that the operations performed need not actively alter anything at the destination but may merely retrieve information from which later action may be prompted. Another option would be to deselect all deploy or upgrade option and only select “relative association” so the objects themselves are not altered but rather the associations are revised. In summary therefore it may be seen from the charts and Figures that the utility employs a graphical user interface having windows for browsing trees in the network and then selecting source objects from the trees and adding them to a source objectlist. A destination list is generated the same way. Options for processing the source objects to the destinations are selectable including maintenance of the source objects relative associations at the destination independent of the absolute associations at the source. Any missing associations are automatically created at the destination when the lists are processed giving the source relativity at the destination. All listed source objects are processed to all the listed destinations upon clicking a single button. The utility includes the full range of deploy, update and replacement processes relating to multiple object types even across different trees including, associations, link folders and ASLs in a ZENworks environment In addition the utility includes a separate object field management tool that enables interrogation of fields in multiple objects in preselected branches and if desired alteration of object fields.

Whilst the above has been given by way of illustrative example of the present invention many variations and modifications will be apparent to those skilled in the art without departing from the broad ambit and scope of the invention as set out in the appended claims.

1. A network administration management utility for a hierarchical tree structure in an computer network, the utility comprising program means enabling user selection of source objects creating an object list, program means enabling user selection of destinations creating a destination list while connected to the network, program means enabling user selection of operations to be processed and program means automatically processing the selected operations in accordance with said lists.

2. A network administration management utility according to claim 1 wherein said selected operations includes program means automatically deploying the selected objects and includes program means enabling upgrade or synchronisation of existing objects at the selected destinations.

3. A network administration management utility according to claim 1 where said selected operations includes program means automatically deploying the selected objects includes program means to replace an existing object at a selected destination by first deleting the existing object.

4. A network administration management utility according to claim 1 further comprising program means enabling a search to identify objects with the same field values.

5. A network administration management utility according to claim 1 further comprising program means enabling associations of a source object not present at a selected destination to be automatically created upon deployment of the object to the selected destination.

6. A network administration management utility according to claim 1 further comprising program means enabling comparison object fields.

7. A network administration management utility according to claim 1 further comprising program means enabling changes to an object to be automatically documented to maintain a history of actions performed in relation to that object.

8. A network administration management utility according to claim 1 further comprising program means enabling retention of a source objects GUID at a selected destination or allocation of a new GUID.

9. A network administration management utility according to claim 1 further comprising program means enabling the same destination list to include destinations in different trees.

10. A network administration management utility according to claim 1 further comprising a graphical user interface having a window showing a selected object tree and respective object and destination list windows.

11. A network administration management utility according to claim 1 wherein said selected operations program means enabling upgrade or synchronisation of existing objects at the selected destinations.

12. A network administration management utility according to claim 1 where said selected operations program means to replace an existing object at a selected destination by first deleting the existing object.

13. A network administration management utility according to claim 1 wherein said selected operations includes program means able to automatically deploy the selected objects, program means able to upgrade or synchronise existing objects at the selected destinations and program means able to replace an existing object at a selected destination by first deleting the existing object.

14. A network administration management utility according to claim 1 wherein said selected operations includes program means able to automatically deploy the selected objects, program means able to upgrade or synchronise existing objects at the selected destinations, program means able to replace an existing object at a selected destination by first deleting the existing object and program means enabling associations of a source object not present at a selected destination to be automatically created upon deployment of the object to the selected destination.

15. A network administration management utility according to claim 1 wherein said selected operations includes program means able to automatically deploy the selected objects, program means able to upgrade or synchronise existing objects at the selected destinations, program means able to replace an existing object at a selected destination by first deleting the existing object and program means enabling the same destination list to include destinations in different trees.

16. A network administration management utility for management of object fields in a hierarchical tree structure in a computer network, the utility including program means enabling interrogation of object fields in multiple objects.

17. A network administration management utility according to claim 16 including user initiated synchronisation of selected fields across selected objects.

18. A network administration management utility according to claim 16 wherein branches of the hierarchical tree structure may be added to a window box to provide a branch list for the purpose of limiting the search to the selected branches.

19. A network administration management utility for management of object fields in a hierarchical tree structure in a computer network, the utility including program means enabling interrogation of object fields in multiple objects, program means enabling user selection of source objects creating an object list, program means enabling user selection of destinations creating a destination list while connected to the network, program means enabling user election of operations to be processed and program means automatically processing the selected operations in accordance with said lists

20. A network administration management utility according to claim 19 wherein said selected operations includes program means automatically deploying the selected objects and includes program means enabling upgrade or synchronisation of existing objects at the selected destinations.

21. A network administration management utility according to claim 19 where said selected operations includes program means automatically deploying the selected objects includes program means to replace an existing object at a selected destination by first deleting the existing object.

22. A network administration management utility according to claim 19 further comprising program means enabling a search to identify objects with the same field values.

23. A network administration management utility according to claim 19 further comprising program means enabling associations of a source object not present at a selected destination to be automatically created upon deployment of the object to the selected destination.

24. A network administration management utility according to claim 19 further comprising program means enabling comparison object fields.

25. A network administration management utility according to claim 19 further comprising program means enabling changes to an object to be automatically documented to maintain a history of actions performed in relation to that object.

26. A network administration management utility according to claim 19 further comprising program means enabling retention of a source objects GUID at a selected destination or allocation of a new GUID.

27. A network administration management utility according to claim 19 further comprising program means enabling the same destination list to include destinations in different trees.

28. A network administration management utility according to claim 19 further comprising a graphical user interface having a window showing a selected object tree and respective object and destination list windows.

29. A network administration management utility according to claim 19 wherein said selected operations program means enabling upgrade or synchronisation of existing objects at the selected destinations.

30. A network administration management utility according to claim 19 where said selected operations program means to replace an existing object at a selected destination by first deleting the existing object.

31. A network administration management utility according to claim 19 wherein said selected operations includes program means able to automatically deploy the selected objects, program means able to upgrade or synchronise existing objects at the selected destinations and program means able to replace an existing object at a selected destination by first deleting the existing object.

32. A network administration management utility according to claim 19 wherein said selected operations includes program means able to automatically deploy the selected objects, program means able to upgrade or synchronise existing objects at the selected destinations, program means able to replace an existing object at a selected destination by first deleting the existing object and program means enabling associations of a source object not present at a selected destination to be automatically created upon deployment of the object to the selected destination.

33. A network administration management utility according to claim 19 wherein said selected operations includes program means able to automatically deploy the selected objects, program means able to upgrade or synchronise existing objects at the selected destinations, program means able to replace an existing object at a selected destination by first deleting the existing object and program means enabling the same destination list to include destinations in different trees.
